(19) United States
(12) Patent Application Publication
(10) Pub. No.: US 2011/0134879 A1
(43) Pub. Date: Jun. 9, 2011

(54) WIRELESS COMMUNICATION DEVICE AND POWER DENSITY SETTING METHOD

(75) Inventors: Yoshihiko Ogawa, Kanagawa (JP); Seigo Nakao, Kanagawa (JP); Katsuhiko Hiramatsu, Kanagawa (JP); Kenichi Miyoshi, Kanagawa (JP); Yuichi Kobayakawa, Osaka (JP)

(73) Assignee: PANASONIC CORPORATION, OSAKA (JP)

(21) Appl. No.: 13/056,838

(22) PCT Filed: Aug. 4, 2009
(86) PCT No.: PCT/JP2009/003717

§ 371 Date: Jan. 31, 2011

(30) Foreign Application Priority Data
Aug. 5, 2008 (JP) 2008-202098

(51) Int. Cl. H04W 52/04; H04W 72/04

(52) U.S. Cl. 370/330; 370/329

(57) ABSTRACT

Disclosed is a wireless communication device that, when both localized transmission and distributed transmission are used, can obtain channel estimation accuracy equivalent to that of localized transmission with distributed transmission. With this device, a setting unit (108) sets the power density of a reference signal by setting the arrangement density in the time domain of the reference signal according to the continuity in the frequency domain of the reference signal. In addition, the setting unit (108) increases the arrangement density in the time domain of the reference signal as the continuity decreases. A transmission RF unit (111) transmits a reference signal having the power density that has been set by the setting unit (108).

### TECHNICAL FIELD

The present invention relates to a radio communication apparatus and a power density setting method.

### BACKGROUND ART

3GPP LTE (3rd Generation Partnership Project Long-term Evolution) or LTE-Advanced, which is developed LTE, is studying use of both localized transmission and distributed transmission in the uplink (see Non-Patent Literature 1.) That is, in communication from each radio communication terminal apparatus (hereinafter “terminal”) to a radio communication base station apparatus (hereinafter “base station”), the transmission method is switched between localized transmission and distributed transmission.

Localized transmission is a transmission method to perform transmission by assigning data signals and reference signals to consecutive frequency bands. For example, as shown in FIG. 1A, with localized transmission, data signals and reference signals are assigned to consecutive transmission bands. With localized transmission, a base station assigns consecutive frequency bands to terminals, respectively, based on the reception quality per frequency band for each terminal, so that it is possible to produce the maximum multiuser diversity effect, that is, frequency scheduling effect.

On the other hand, distributed transmission is a transmission method by assigning data signals and reference signals to discontinuous frequency bands distributed over a wide area. For example, as shown in FIG. 1B, with distributed transmission, data signals and reference signals are assigned to transmission bands distributed over all frequency bands. With distributed transmission, it is possible to reduce the probability of all data signals or reference signals from one terminal falling on a fading bottom, that is, to produce frequency diversity effect and prevent deterioration of reception performances.

In addition, with LTE, each terminal transmits data signals and a reference signal in one transmission band as shown in FIG. 1A and FIG. 1B (see Non-Patent Literature 2.) Then, a base station estimates the channel estimation value for transmission bands to which data signals from each terminal are assigned, using reference signals to demodulate these data signals.

### CITATION LIST

### Non-Patent Literature

### [NPL 1]

R1-062513, “Performance comparison between LFDMA and DFDMA transmission in UL”, 3GPP RAN WG1 #46 his meeting, Seoul, KOREA, Oct. 9-13, 2006

### [NPL 2]

3GPP TS 36.212 V8.1.0, “Multiplexing and channel coding (Release 8),” 2007-11

### SUMMARY OF INVENTION

### Technical Problem

As shown in FIG. 1A, with localized transmission, all transmission bands to assign reference signals from one terminal to, continue, so that channel correlation is high. Therefore, with localized transmission, it is possible to produce high filtering effect and ensure satisfactory accuracy of channel estimation. On the other hand, as shown in FIG. 1B, with distributed transmission, transmission bands to assign reference signals from one terminal to, do not continue, so that channel correlation is low. Therefore, with distributed transmission, it is only possible to produce low filtering effect, so that the accuracy of channel estimation decreases.

Accordingly, when both localized transmission and distributed transmission are used, the accuracy of channel estimation at the time of distributed transmission is lower than at the time of localized transmission. That is, when terminals use distributed transmission, it is only possible to produce lower accuracy of channel estimation than in a case of use of localized transmission.

It is therefore an object of the present invention to provide a radio communication apparatus and a power density setting method to ensure the accuracy of channel estimation for localized transmission even by distributed transmission when both localized transmission and distributed transmission are employed.

### Solution to Problem

The radio communication apparatus according to the present invention adopts a configuration to include: a setting section that sets a power density of reference signals, according to a degree of continuity of the reference signals in a frequency domain; and a transmitting section that transmits the reference signals having the power density. When the degree of continuity is lower, the setting section increases the power density.

The power density setting method according to the present invention includes: setting a power density of reference signals, according to a degree of continuity of the reference signals in a frequency domain. When the degree of continuity is lower, the power density is increased.

### Advantageous Effects of Invention

According to the present invention, when both localized transmission and distributed transmission are used, it is possible to ensure the accuracy of channel estimation for localized transmission even by distributed transmission.

### BRIEF DESCRIPTION OF DRAWINGS

FIG. 1A shows transmission bands for reference signals at the time of localized transmission;

FIG. 1B shows transmission bands for reference signals at the time of distributed transmission;

FIG. 2 is a block diagram showing a configuration of a terminal according to Embodiment 1 of the present invention;

FIG. 3 is a block diagram showing a configuration of a base station according to Embodiment 1 of the present invention;

FIG. 4A shows processing to map reference signals according to Embodiment 1 of the present invention (in a case of localized transmission);

FIG. 4B shows processing to map reference signals according to Embodiment 1 of the present invention (in a case of distributed transmission);

FIG. 5 shows associations between degrees of continuity and allocation densities of reference signals according to Embodiment 1 of the present invention;

FIG. 6 shows another processing to map reference signals according to Embodiment 1 of the present invention;

FIG. 7 shows associations between degrees of continuity and allocation densities of reference signals according to Embodiment 1 of the present invention;

FIG. 8A shows processing to set the allocation density of reference signals according to Embodiment 1 of the present invention;

FIG. 8B shows processing to set the allocation density of reference signals according to Embodiment 1 of the present invention;

FIG. 9A shows processing to set the allocation density of reference signals according to Embodiment 2 of the present invention;

FIG. 9B shows processing to set the allocation density of reference signals according to Embodiment 2 of the present invention;

FIG. 10 shows the transmission power for each symbol in one slot according to Embodiment 3 of the present invention;

FIG. 11 shows associations between degrees of continuity and reference signal transmission power according to Embodiment 3 of the present invention;

FIG. 12 shows associations between degrees of continuity and reference signal transmission power according to Embodiment 3 of the present invention;

FIG. 13A shows processing to set reference signal transmission power according to Embodiment 3 of the present invention;

FIG. 13B shows processing to set reference signal transmission power according to Embodiment 3 of the present invention;

FIG. 14A shows processing to set reference signal transmission power according to Embodiment 4 of the present invention;

FIG. 14B shows processing to set reference signal transmission power according to Embodiment 4 of the present invention;

FIG. 15 shows a plurality of setting patterns according to the present invention (in a case of allocation density); and

FIG. 16 shows a plurality of setting patterns according to the present invention (in a case of transmission power.)

### DESCRIPTION OF EMBODIMENTS

Now, embodiments of the present invention will be described in detail with reference to the accompanying drawings.

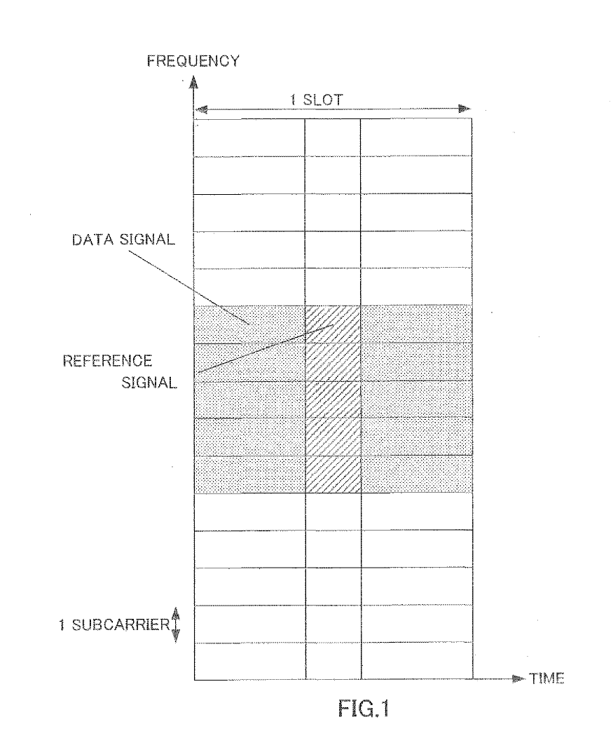

In the following descriptions, a transmission method to transmit signals such that a plurality of transmission bands assigned to one terminal all continue in the frequency domain, is localized transmission. For example, as shown in FIG. 1A, with localized transmission, data signals and reference signals from one terminal are assigned to five consecutive subcarriers. On the other hand, a transmission method to transmit signals such that at least one of a plurality of transmission bands assigned to one terminal does not continue, is distributed transmission. For example, as shown in FIG. 1B, with distributed transmission, data signals and reference signals from one terminal are assigned to five discontinuous subcarriers at intervals of two subcarriers.

Here, the accuracy of channel estimation is influenced by the phase relationship between channel estimation values (that is, whether channel estimation values are in phase or different phases) for transmission bands to which assign reference signals are assigned. For example, as shown in FIG. 1A, when all transmission bands to assign reference signals to continue (that is, in a case of localized transmission), channel correlation is high, so that channel estimation values in transmission bands are highly likely to be in phase. Therefore, at the time of channel estimation, channel estimation values for transmission bands are added approximately in phase, so that it is possible to produce high filtering effect and ensure satisfactory accuracy of channel estimation.

By contrast with this, when transmission bands to assign reference signals to are not continued (that is, in a case of distributed transmission) as shown in FIG. 1B, channel correlation is low, so that channel estimation values for transmission bands are in different phases. Therefore, at the time of channel estimation, channel estimation values for transmission bands are added in different phases, so that it is only possible to produce low filtering effect, and therefore the accuracy of channel estimation decreases.

As described above, when transmission bands to assign reference signals to do not continue, that is, when a distance between transmission bands to assign reference signals to, is longer in the frequency domain, channel estimation values for transmission bands are more likely to be in different phases, so that the accuracy of channel estimation decreases. In other words, when a degree of continuity of transmission bands to assign reference signals to (that is, a degree of continuity of reference signals in the frequency domain) lower, the accuracy of channel estimation decreases.

Therefore, when a degree of continuity of reference signals in the frequency domain is lower, the effect of improving the accuracy of channel estimation is higher by increasing the power density of reference signals. Therefore, according to the present invention, when a degree of continuity of reference signals in the frequency domain is lower, terminals set the power density of reference signals higher.

### Embodiment 1

With the present embodiment, the proportion of transmission bands for reference signals in a predetermined frequency band is used as the degree of continuity of reference signals in the frequency domain, and, when the proportion is smaller, the allocation density of reference signals in the time domain is increased.

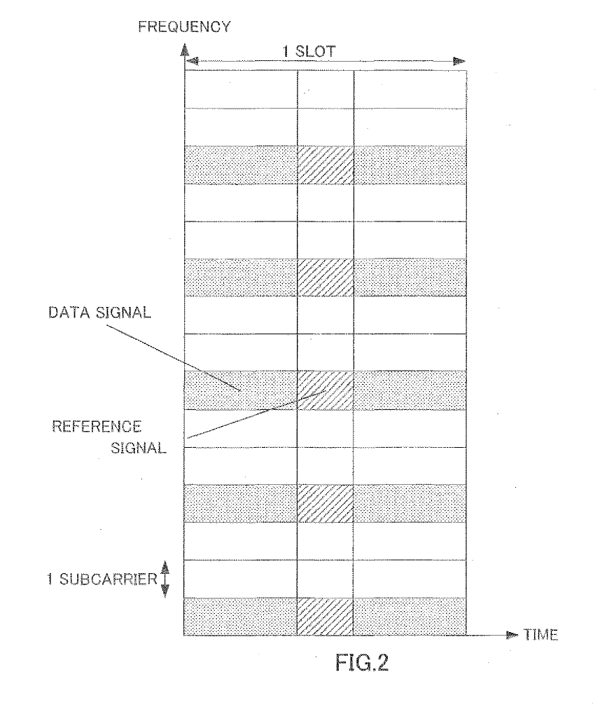

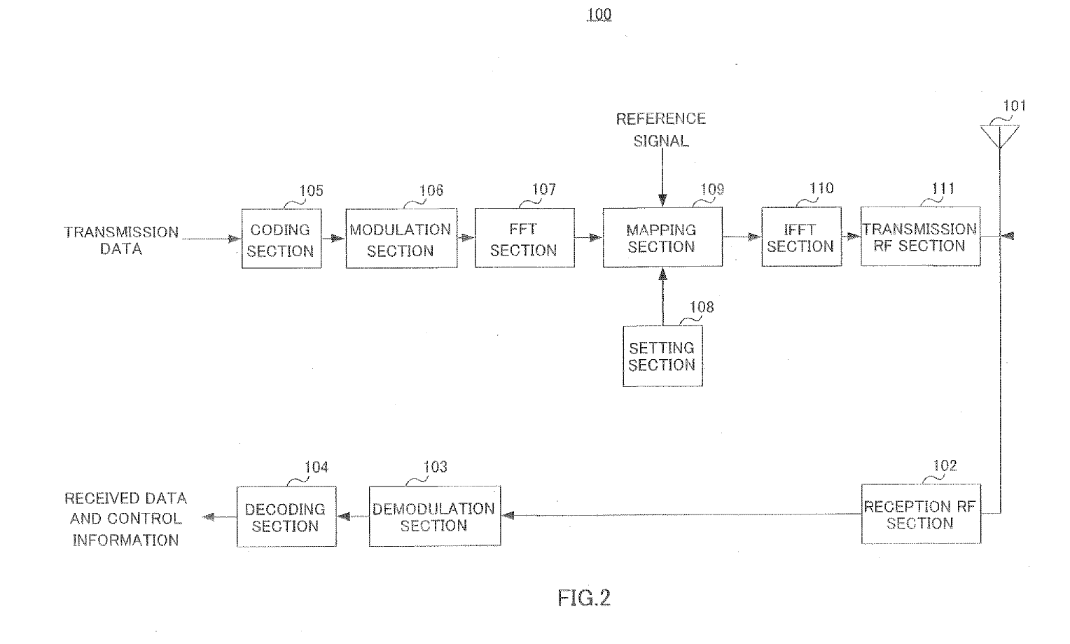

Now, a configuration of terminal 100 according to the present embodiment will be explained with reference to FIG. 2.

Reception RF section 102 in terminal 100 shown in FIG. 2 applies reception processing, including down-conversion, A/D conversion and so forth, on a signal received via antenna 101 and outputs a signal to which reception processing has been applied, to demodulation section 103.

Demodulation section 103 applies equalizing processing and demodulation processing on the signal inputted from reception RF section 102 and outputs a signal to which equalizing processing and demodulation processing have been applied, to decoding section 104.

Decoding section 104 applies decoding processing to the signal inputted from demodulation section 103 and extracts received data and control information.

Coding section 105 encodes transmission data and outputs encoded data to modulation section 106.

Modulation section 106 modulates the encoded data inputted from coding section 105 and outputs a modulated data signal to FFT (fast Fourier transform) section 107.

FFT section 107 applies FFT processing to the data signal inputted from modulation section 106. Then, FFT section 107 outputs a data signal to which FFT processing has been applied, to mapping section 109.

Setting section 108 sets the power density of reference signals by setting the allocation density of reference signals in the time domain, according to the degree of continuity of reference signals in the frequency domain. Here the proportion of transmission bands for reference signals in a predetermined frequency band is the degree of continuity. In addition, for example, the proportion of the number of allocation of reference signals in one subcarrier and one slot (seven symbols) is the allocation density of reference signals in the time domain. Then, when the proportion of transmission bands for reference signals in a predetermined frequency band is lower (the degree of continuity is lower), setting section 108 increases the allocation density of reference signals in the time domain. That is, when the degree of continuity of reference signals in the frequency domain is lower, setting section 108 increases the power density of reference signals. In other words, when the proportion of transmission bands for reference signals in a predetermined frequency band is lower (the degree of continuity is lower), setting section 108 increases the number of reference signals in a certain time range (e.g. one slot.) Then, setting section 108 outputs the set allocation density of reference signals to mapping section 109.

Mapping section 109 maps data signals and reference signals inputted from FFT section 107 to resources in the frequency domain and the time domain, according to the allocation density of reference signals inputted from setting section 108. For example, mapping section 109 holds mapping patterns for data signals and reference signals, which match the allocation density of reference signals inputted from setting section 108, and maps data signals and reference signals according to the allocation density of reference signals. Then, mapping section 109 outputs a signal in which data signals and reference signals are mapped, to IFFT (inverse fast Fourier transform) section 110.

IFFT section 110 applies IFFT processing to the signal inputted from mapping section 109. Then, IFFT section 110 outputs a signal to which IFFT processing has been applied, to transmission RF section 111.

Transmission RF section 111 applies transmission processing, including D/A conversion, up-conversion, amplification and so forth, to the signal inputted from IFFT section 110, and transmits a signal to which transmission processing has been applied, from antenna 101 to base station 150 by radio. By this means, transmission RF section 111 transmits reference signals having the power density set in setting section 108.

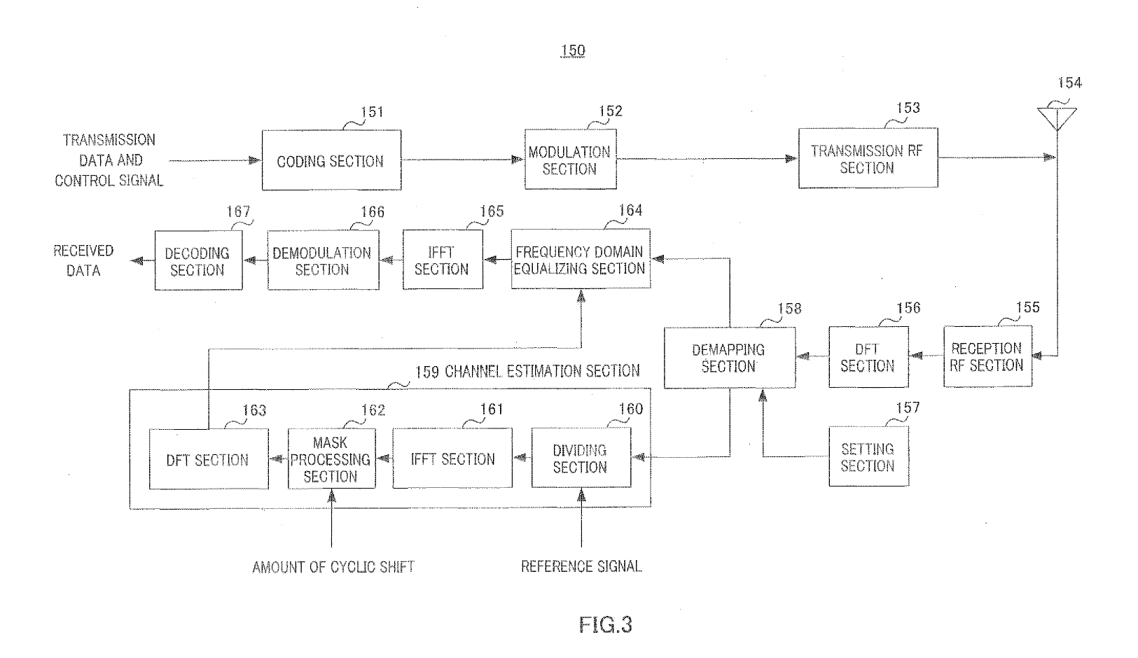

Next, a configuration of base station 150 according to the present embodiment will be explained with reference to FIG. 3.

Coding section 151 in base station 150 shown in FIG. 3 encodes transmission data and a control signal and outputs encoded data to modulation section 152.

Modulation section 152 modulates the encoded data inputted from coding section 151 and outputs a signal after modulation to transmission RF section 153.

Transmission RF section 153 applies transmission processing including D/A conversion, up-conversion, amplification and so forth, to the signal inputted from modulation section 152 and transmits a signal to which transmission processing has been applied, from antenna 154 by radio.

Reception. RE section 155 applies reception processing, including down-conversion, A/D conversion and so forth, to the signal received via antenna 154 and outputs a signal to which reception processing has been applied, to DFT (discrete Fourier transform) section 156.

DFT section 156 applies DFT processing to the signal inputted from reception RF section 155 and transforms a time domain signal to a frequency domain signal. Then, DFT section 156 outputs the frequency domain signal to demapping section 158.

Like setting section 108 (FIG. 2), setting section 157 sets the allocation density of reference signals in the time domain, according to the degree of continuity of reference signals in the time domain. Here, when the proportion (degree of continuity) of transmission bands for reference signals in a predetermined frequency band is lower, setting section 157 increases the allocation density of reference signals. Then, setting section 157 outputs the set allocation density of reference signals to demapping section 158.

Demapping section 158 extracts data signals and reference signals from frequency domain signals inputted from DFT section 156, according to the allocation density of reference signals inputted from setting section 157. For example, demapping section 158 holds mapping patterns for data signals and reference signals matching the allocation density of reference signals inputted from setting section 157, and extracts data signals and reference signals, according to the allocation density of reference signals. Then, demapping section 158 outputs extracted data signals to frequency equalizing section 164 and outputs extracted reference signals to dividing section 160 in channel estimating section 159.

Channel estimating section 159 has dividing section 160, IFFT section 161, mask processing section 162 and DFT section 163, and performs channel estimation, based on reference signals inputted from demapping section 158. Now, the internal configuration of channel estimating section 159 will be explained in detail.

Dividing section 160 divides a reference signal inputted from demapping section 158 by a preset reference signal. Then, dividing section 160 outputs the division result (correlation value) to IFFT section 161.

IFFT section 161 applies IFFT processing to a signal inputted from dividing section 160. Then, IFFT section 161 outputs a signal to which IFFT processing has been applied, to mask processing section 162.

Mask processing section 162 as an extracting means, applies mask processing to the signal inputted from IFFT section 161, based on the amount of cyclic shift inputted, to extract the correlation value of the interval (detecting window) in which there is the correlation value of a desired cyclic shift sequence. Then, mask processing section 162 outputs the extracted correlation value to DFT section 163.

DFT section 163 applies the correlation value inputted from mask processing section 162. Then, DFT section 163 outputs a correlation value to which DFT processing has been applied, to frequency equalizing section 164. Here, signals outputted from DFT section 163 represent frequency variation in a channel (frequency response in a channel.)

Frequency domain equalizing section 164 applies equalizing processing to a data signal inputted from demapping section 158, using the signal (frequency response in a channel) inputted from DFT section 163 in channel estimating section 159. Then, frequency domain equalizing section 164 outputs a signal to which equalizing processing has been applied, to IFFT section 165.

IFFT section 165 applies IFFT processing to the data signal inputted from frequency domain equalizing section 164. Then, IFFT section 165 outputs a signal to which IFFT processing has been applied, to demodulation section 166.

Demodulation section 166 applies demodulation processing to the signal inputted from IFFT section 165 and outputs a signal to which demodulation processing has been applied, to decoding section 167.

Decoding section 167 applies decoding processing to the signal inputted from demodulation section 166 and extracts received data.

Next, a setting example of the allocation density of reference signals in the time domain in setting section 108 (FIG. 2) in terminal 100 and setting section 157 (FIG. 3) in base station 150 according to the present embodiment, will be explained.

In the following descriptions, one slot is composed of seven symbols. In addition, the allocation density of reference signals is represented by the proportion of the number of reference signals allocated to seven symbols in one slot. For example, when, among seven symbols, data signals are allocated to six symbols and a reference signal is allocated to one symbol, the allocation density of reference signals is 1/7. In addition, for example, when, among seven symbols, data signals are allocated to five symbols and reference signals are allocated to two symbols, the allocation density of reference signals is 2/7.

### Setting example 1-1

With this setting example, setting section 108 and setting section 157 increase the allocation density of reference signals in the time domain in a case in which the degree of continuity of reference signals in the frequency domain is lower than 1, more than in a case in which the degree of continuity of reference signals in the frequency domain is 1.

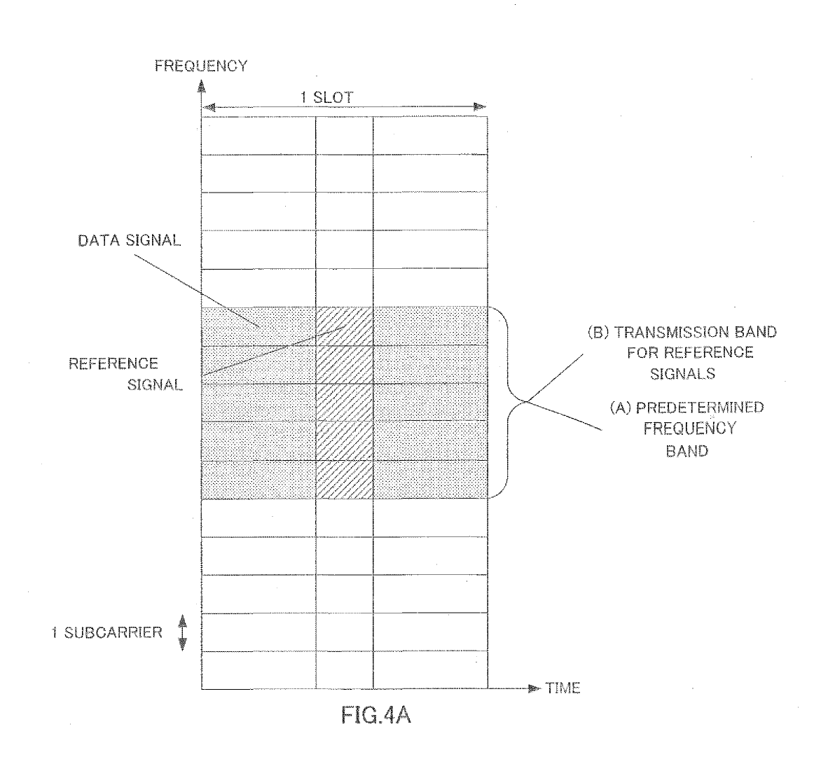

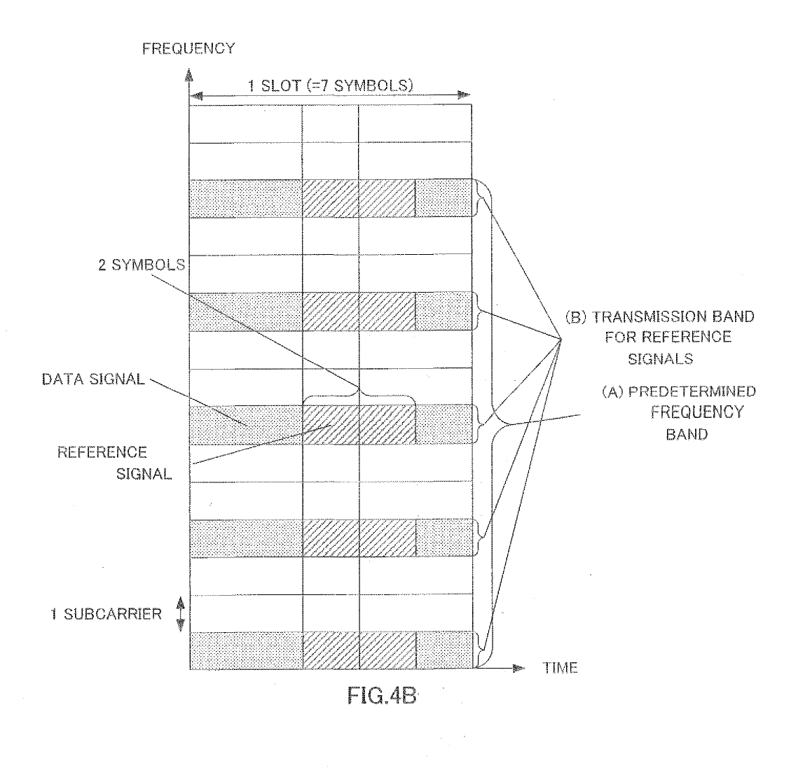

In the following descriptions, the entire frequency band to assign reference signals from terminal 100 to (that is, the frequency interval in which reference signals from terminal 100 are assigned, from the transmission band at one end to the transmission band at the other end, is a predetermined frequency band. For example, as shown in FIG. 4A, when signals (data signals and reference signals) from terminal 100 are transmitted by localized transmission, a predetermined frequency band (A) is equivalent to five carriers and transmission bands (B) for reference signals are also equivalent to five carriers. Therefore, the proportion of transmission band (B) for reference signals in a predetermined frequency band (A): B/A (the degree of continuity) is 1 (= 5/5). That is, the degree of continuity (proportion B/A) at the time of localized transmission is maximum value 1.

On the other hand, as shown in FIG. 4B, signals (data signals and reference signals) from terminal 100 are transmitted by distributed transmission, a predetermined frequency band (A) is equivalent to thirteen subcarriers and transmission bands (B) for reference signals is equivalent to five subcarriers. Therefore, the proportion of transmission bands (B) for reference signals in a predetermined frequency band (A): B/A (the degree of continuity) is 5/13 That is, the degree of continuity (proportion B/A) at the time of distributed transmission is lower than 1.

Therefore, setting section 108 and setting section 157 increase the allocation density of reference signals in the time domain at the time of distributed transmission where the degree of continuity (proportion B/A) is lower than 1, more than at the time of localized transmission where the degree of continuity (proportion B/A) is the maximum value 1.

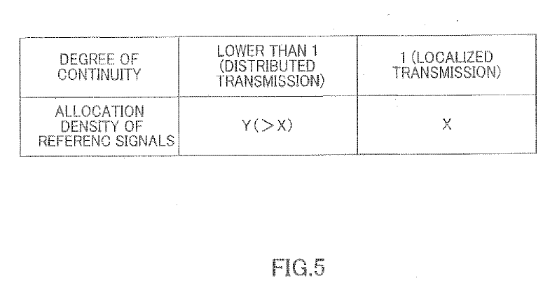

For example, as shown in FIG. 5, at the time of localized transmission where the degree of continuity (proportion B/A) is 1, setting section 108 and setting section 157 set the allocation density of reference signals in the time domain to X. On the other hand, at the time of distributed transmission where the degree of continuity (proportion B/A) is lower than 1, setting section 108 and setting section 157 set the allocation density of reference signals in the time domain to Y higher than X. Here, for example, the allocation density X of reference signals in the time domain may be 1/7 like in the above described prior art, and the allocation density Y of reference signals in the time domain may be 2/7 greater than X= 1/7.

Next, processing to map reference signals in mapping section 109 (FIG. 2) in terminal 100 will be explained. Here, allocation density X of reference signals in the time domain and allocation density Y of reference signals in the time domain shown in FIG. 5 are 1/7 and 2/7, respectively.

That is, when the degree of continuity is 1 (localized transmission), the allocation density of reference signals in the time domain is 1/7, so that mapping section 109 maps a reference signal to one symbol in one slot (seven symbols) as shown in FIG. 4A. By contrast with this, when the degree of continuity is lower than 1 (distributed transmission), the allocation density Y of reference signals in the time domain is 2/7, so that mapping section 109 maps reference signals to two symbols in one slot (seven symbols) as shown in FIG. 4B. By this means, in terminal 100, the power density of reference signals is higher at the time of distributed transmission where the degree of continuity is lower than 1, than at the time of localized transmission where the degree of continuity is 1.

As described above, terminal 100 increases the allocation density of reference signals in the time domain at the time the degree of continuity is lower than 1 (distributed transmission), more than at the time the degree of continuity is 1 (localized transmission.) By this means, with distributed transmission, even if the degree of continuity is low and the channel correlation between transmission bands to which reference signals are assigned, is low, it is possible to improve the accuracy of channel estimation by increasing the power density of reference signals. In other words, with distributed transmission, it is possible to compensate for deterioration of the accuracy of channel estimation due to low channel correlation in the frequency domain by increasing the power density of reference signals. On the other hand, with localized transmission, even if the power density of reference signals is low, the channel correlation between transmission bands to which reference signals are assigned, is high, so that it is possible to ensure satisfactory accuracy of channel estimation. Consequently, with localized transmission, it is possible to reduce reference signal overhead by reducing the allocation density of reference signals.

As described above, according to this setting example, terminals set the power density of reference signals by setting the allocation density of reference signals in the time domain, according to the degree of continuity of reference signals in the frequency domain. By this means, at the time of distributed transmission where the degree of continuity is lower than 1, it is possible to improve the accuracy of channel estimation by increasing the allocation density of reference signals in the time domain. Therefore, according to this setting example, when both localized transmission and distributed transmission are employed, it is possible to ensure the accuracy of channel estimation for localized transmission even by distributed transmission. That is, it is possible to ensure satisfactory accuracy of channel estimation whether the transmission method is localized transmission or distributed transmission.

In addition, with this setting example, at the time of localized transmission where the degree of continuity is 1, terminals do not increase the allocation density of reference signals in the time domain, so that it is possible to reduce reference signal overhead.

Here, with this setting example, a case has been explained where setting section 108 and setting section 157 set the allocation density of reference signals in the time domain to X when the degree of continuity is 1, and set the allocation density of reference signals in the time domain to Y when the degree of continuity is lower than 1, as shown in FIG. 5. However, according to the present invention, for example, setting section 108 and setting section 157 may set the allocation density of reference signals in the time domain to X shown in FIG. 5 when the degree of continuity is equal to or higher than a predetermined threshold, and set the allocation density of reference signals in the time domain to Y shown in FIG. 5 when the degree of continuity is lower than a predetermined threshold.

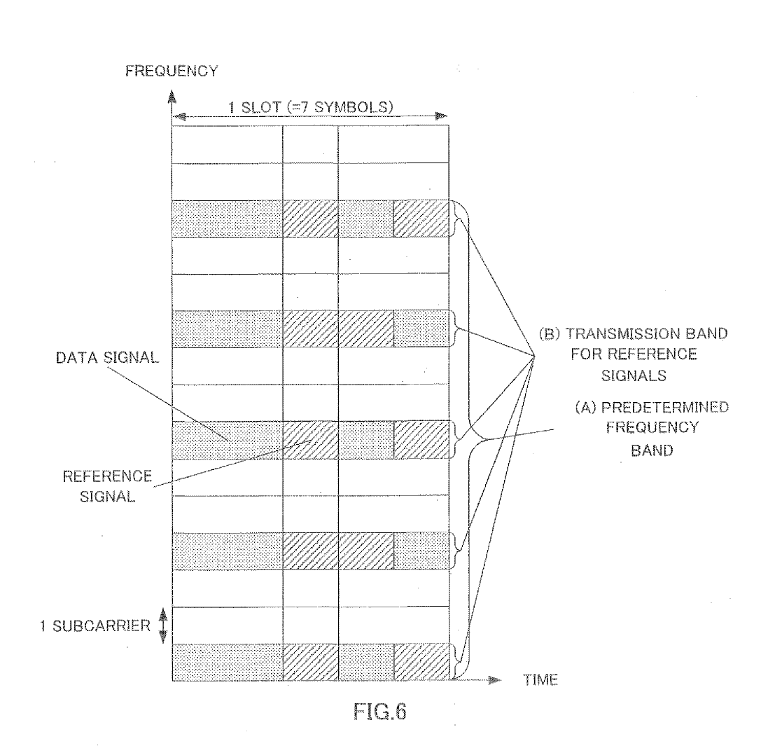

Moreover, with this setting example, a case has been explained where, in order to increase an allocation density of reference signals in the time domain, mapping section 109 maps reference signals to one symbol in all transmission bands to assign reference signals to (mapping on a per symbol basis), as shown in FIG. 5. However, with the present invention, mapping section 109 may, for example, map reference signals on a per subcarrier basis such that reference signals are mapped to different symbols between subcarriers as shown in FIG. 6. That is, in one symbol, data signals or reference signals are mapped to different transmission bands.

### Setting Example 1-2

With this setting example, when the degree of continuity (proportion B/A) of reference signals in the frequency domain is lower, setting section 108 and setting section 157 increase the allocation density of reference signals in the time domain.

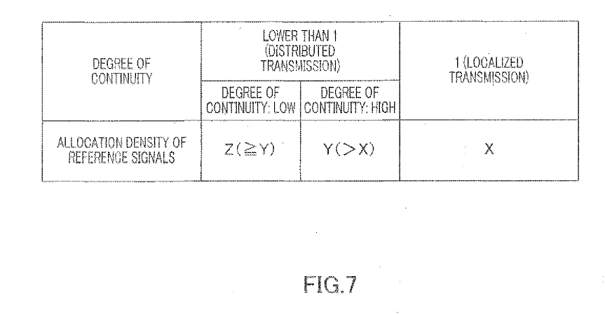

For example, as shown in FIG. 7, when the degree of continuity (proportion B/A) is 1, setting section 108 and setting section 157 set the allocation density of reference signals in the time domain, to X (e.g. X= 1/7) like in setting example 1-1.

On the other hand, when the degree of continuity (proportion B/A) is lower than 1, setting section 108 and setting section 157 set the allocation density of reference signals in the time domain higher than in the case in which the degree of continuity (proportion B/A) is 1, like in setting example 1-1. For example, when the degree of continuity (proportion B/A) is lower than 1, setting section 108 and setting section 157 sets the allocation density of reference signals in the time domain Y higher than X, or sets the allocation density Z equal to or higher than Y, as shown in FIG. 7. Here, when the degree of continuity (proportion B/A) is lower, setting section 108 and setting section 157 increases the allocation density of reference signals in the time domain. For example, as shown in FIG. 7, among degrees of continuity (proportion B/A) lower than 1, when a degree of continuity (proportion B/A) is higher, the allocation density of reference signals in the time domain is set to a value closer to Y (e.g. Y= 2/7.) On the other hand, when a degree of continuity (proportion B/A) is lower, setting section 108 and setting section 157 set the allocation density of reference signals in the time domain to a value closer to Z (e.g. X= 3/7.) That is, when the degree of continuity (proportion B/A) is lower than 1, setting section 108 and setting section 157 set the allocation density of reference signals in the time domain to any of Y to Z, according to the degree of continuity (proportion B/A.)

As described above, when the degree of continuity (proportion B/A) is lower than 1 (distributed transmission), terminal 100 increases the allocation density of reference signals in the time domain more than in the case in which the degree of continuity is 1 (localized transmission) like in setting example 1-1. Moreover, in a case in which the degree of continuity (proportion B/A) is lower than 1 (distributed transmission), terminal 100 increases the allocation density of reference signals in the time domain when the degree of continuity (proportion B/A) is lower. By this means, at the time of distributed transmission where the degree of continuity (proportion B/A) is lower than 1, terminal 100 can set the allocation density of reference signals in the time domain more finely than in setting example 1-1, according to the degree of continuity (proportion B/A.) That is, terminal 100 can finely set the allocation density of reference signals in the time domain, according to the degree of continuity (proportion B/A), so that it is possible to minimize increase in the allocation density of reference signals in the time domain.

As described above, according to this setting example, at the time of distributed transmission where the degree of continuity is lower than 1, it is possible to improve the accuracy of channel estimation while reference signal overhead is minimized.

### Setting example 1-3

Although with setting example 1-1 and setting example 1-2, the cases have been explained where the entire frequency band to which reference signals from terminal 100 are assigned, is a certain frequency band, with this setting example, a case will be explained where frequency bands around each of transmission bands (subcarriers) for reference signals are predetermined frequency bands.

That is, with the present embodiment, the proportion of transmission bands for reference signals to frequency bands in a predetermined range around each transmission band is used as a degree of continuity. Then, for example, when the proportion (degree of continuity) of transmission bands for reference signals in a predetermined frequency band is lower than a threshold, setting section 108 and setting section 157 increase the allocation density of reference signals in the time domain, and, when the proportion (degree of continuity) of transmission bands for reference signals in a predetermined frequency band is equal to or higher than a threshold, decrease the allocation density of reference signals in the time domain. That is, when the degree of continuity is lower than a threshold, setting section 108 and setting section 157 increase the number of reference signals in the time domain, and, when the degree of continuity is equal to or higher than a threshold, do not increase the number of reference signals in the time domain.

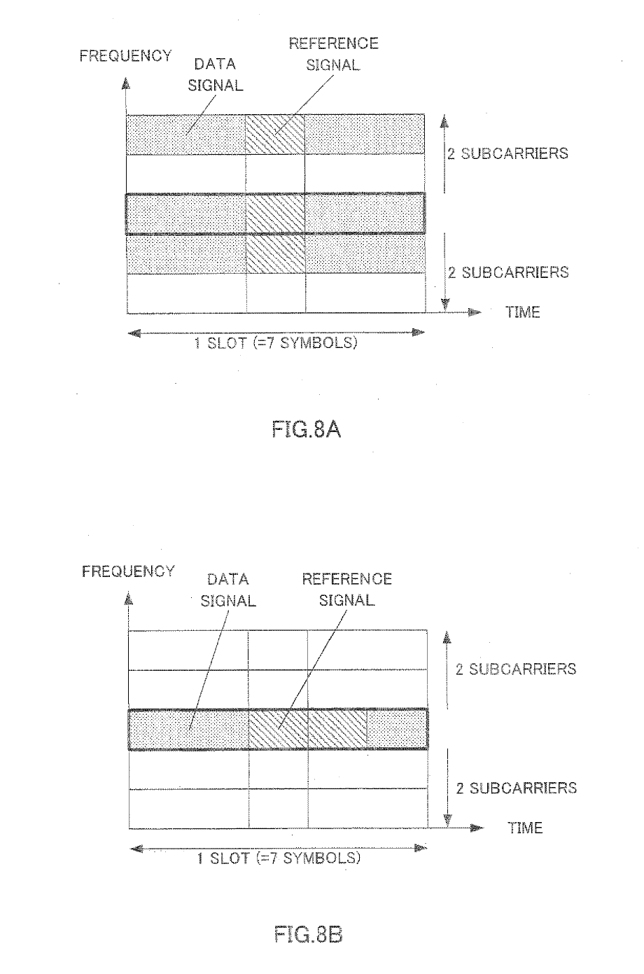

Now, specific descriptions will be explained. Here, four subcarriers composed of two subcarriers before a subject transmission band (for example, the center subcarrier of five subcarriers shown in FIG. 8A or FIG. 8B) and two subcarriers after the subject subcarrier are frequency bands in a predetermined range, that is, predetermined frequency bands. In addition, a threshold is ½. Moreover, when the proportion (degree of continuity) of transmission bands for reference signals in predetermined bands is equal to or higher than the threshold, the allocation density of reference signals in the time domain is 1/7, and when the proportion (degree of continuity) of transmission bands for reference signals in predetermined frequency bands is lower than the threshold, the allocation density of reference signal in the time domain is 2/7.

In a case shown in FIG. 8A, the proportion (continuity) of transmission bands (two subcarriers) for reference signals to predetermined frequency bands (four subcarriers) is ½ (= 2/4.) Therefore, setting section 108 and setting section 157 set the allocation density of reference signals in the time domain, to 1/7 because the proportion (continuity) is equal to or higher than the threshold. Accordingly, mapping section 109 maps a reference signal to one symbol among seven symbols in the subject transmission band (the center subcarrier shown in FIG. 8A.)

Meanwhile, in a case shown in FIG. 8B, the proportion (degree of continuity) of transmission bands (zero subcarrier) for reference signals to predetermined frequency bands (four subcarriers) is zero (= 0/4.) Therefore, setting section 108 and setting section 157 set the allocation density of reference signals in the time domain, to 2/7 because the proportion (continuity) is lower than the threshold. Accordingly, mapping section 109 maps reference signals to two symbols among seven symbols in the subject transmission band (the center subcarrier shown in FIG. 8B.)

As described above, setting section 108 and setting section 157 increase the allocation density of reference signals in the time domain in FIG. 8B more than in FIG. 8A. By this means, as shown in FIG. 8A, when the proportion of transmission bands for reference signals occupying in predetermined frequency bands is high, the channel correlation between the subject transmission band and frequency bands in a predetermined range increases, so that it is possible to ensure satisfactory accuracy of channel estimation even if the allocation density of reference signals in the time domain is low. By contrast with this, as shown in FIG. 8B, when the proportion of transmission bands for reference signals occupying in predetermined frequency bands is low, although the channel correlation between the subject transmission band and predetermined frequency bands is low, it is possible to improve the accuracy of channel estimation by increasing the allocation density of reference signals in the time domain.

As described above, terminal 100 sets the allocation density of reference signals in the time domain, according to the degree of continuity for each of transmission bands assigned to reference signals from terminal 100. By this means, in transmission bands where the degree of continuity is high, it is possible to reduce reference signal overhead by decreasing the allocation density of reference signals in the time domain. On the other hand, in transmission bands where the degree of continuity is low, it is possible to improve the accuracy of channel estimation by increasing the allocation density of reference signals in the time domain.

Therefore, with this setting example, it is possible to finely set the allocation density of reference signals in the time domain per transmission band, based on the positions of transmission bands used to transmit reference signals from each terminal. By this means, it is possible to improve the accuracy of channel estimation while reference signal overhead is minimized.

Setting examples 1-1 to 1-3 of the allocation density of reference signals in the time domain have been explained.

As described above, with the present embodiment, when the degree of continuity of reference signals in the frequency domain is lower, terminals set the allocation density of reference signals in the time domain (that is, the power density of reference signals) higher. By this means, the power density of reference signals in the time domain increases, so that it is possible to compensate for deterioration of the accuracy of channel estimation in the frequency domain. Therefore, according to the present embodiment, when both localized transmission and distributed transmission are employed, it is possible to ensure the accuracy of channel estimation for localized transmission even by distributed transmission. That is, even if both localized transmission and distributed transmission, it is possible to ensure satisfactory accuracy of channel estimation whether localized transmission or distributed transmission is used.

Moreover, according to the present embodiment, the allocation density of reference signals in the time domain is lower when a degree of continuity is higher, so that it is possible to reduce reference signal overhead.

Here, with the present embodiment, when the degree of continuity of reference signals in the frequency domain is lower, a base station may select whether or not to increase the allocation density of reference signals in the time domain. For example, while setting the allocation density to 1/7 in localized transmission where the degree of continuity is high, like in the above-described embodiment, a base station may select whether to increase the allocation density (e.g. allocation density 2/7) or to decrease the allocation density (e.g. allocation density 1/7) in distributed transmission where the degree of continuity is low.

In addition, each terminal is highly likely not to know transmission methods (localized transmission and distributed transmission) of other terminals. Therefore, when the allocation density of reference signals is increased, that is, when the number of reference signals is increased, if reference signals are added to transmission bands other than the transmission bands to which data signals from a subject terminal are assigned, these added reference signals are likely to collide with data signals or reference signals from other terminals. Therefore, when the allocation density of reference signals is higher, it is preferable that a terminal increases the allocation density of reference signals in the time domain to add reference signals to the same frequency band as the transmission band for data signals, as described in the present embodiment. By this means, it is possible to prevent reference signals from colliding with signals from other terminals in bands to which reference signals are added, and in addition, signaling for reporting added reference signals is no longer required.

### Embodiment 2

With Embodiment 1, a case has been explained where the proportion of transmission bands for reference signals to predetermined frequency bands is the degree of continuity of reference signals in the frequency domain. By contrast with this, with the present embodiment, a case will be explained where a frequency interval between neighboring reference signals in the frequency domain is the degree of continuity of reference signals in the frequency domain.

For example, as shown in FIG. 1A, when signals from terminal 100 is transmitted by localized transmission, transmission bands to assign reference signals from terminal 100 to, continue, so that the frequency interval between neighboring reference signals is the minimum value 0. On the other hand, as shown in FIG. 1B, when signals from terminals 100 are transmitted by distributed transmission, the frequency interval between neighboring reference signals is equivalent to two subcarriers. That is, with the present embodiment, the degree of continuity of reference signals in the frequency domain is maximized when the frequency interval between neighboring reference signals is minimized like at the time of localized transmission. In addition, the degree of continuity of reference signals in the frequency domain is lower when the frequency interval between neighboring reference signals is greater.

Therefore, setting section 108 (FIG. 2) in terminal 100 and setting section 157 (FIG. 3) in base station 150 according to the present embodiment set the allocation density of reference signals in the time domain for each of transmission bands to which reference signals from terminal 100 are assigned, according to the frequency interval between neighboring reference signals. Here, when the frequency interval between neighboring reference signals is greater (that is, the degree of continuity is lower, setting section 108 and setting section 157 increase the allocation density of reference signals in the time domain. In addition, when the frequency interval between neighboring reference signals is greater than a threshold, setting section 108 and setting section 157 increase the allocation density of reference signals in the time domain, and, when the frequency interval between neighboring reference signals is smaller than a threshold, decrease the allocation density of reference signals in the time domain.

Now, specific descriptions will be explained. In the following descriptions, one slot is composed of seven symbols like in Embodiment 1. In addition, the allocation density of reference signals in the time domain is represented by the proportion of the number of reference signals allocated to seven symbols in one slot. The threshold of frequency intervals is two subcarriers. In addition, when a frequency interval is smaller than the threshold, the allocation density of reference signals in the time domain is 1/7, and, when a frequency interval is equal to or greater than the threshold, the allocation density of reference signals in the time domain is 2/7.

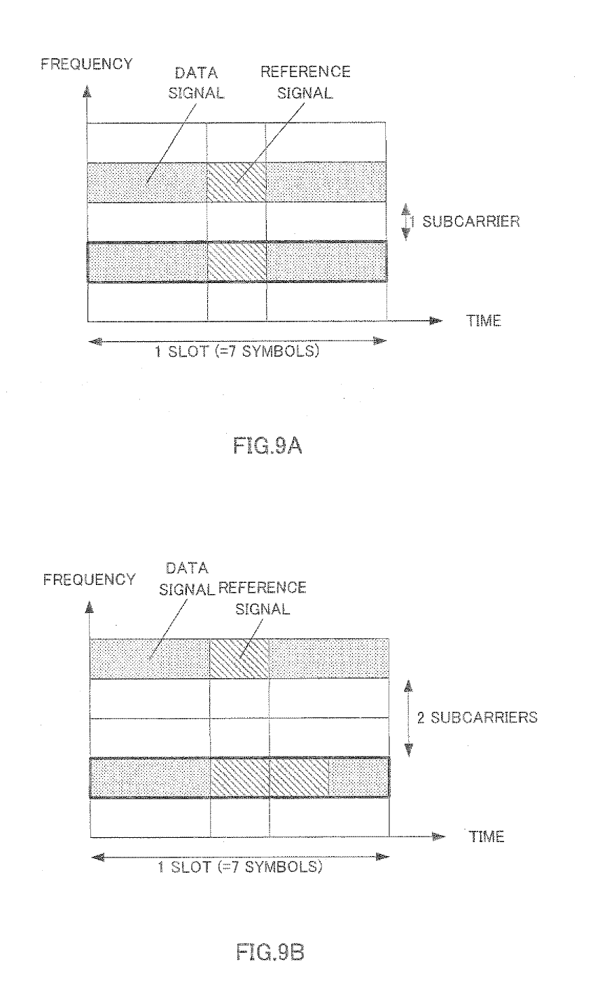

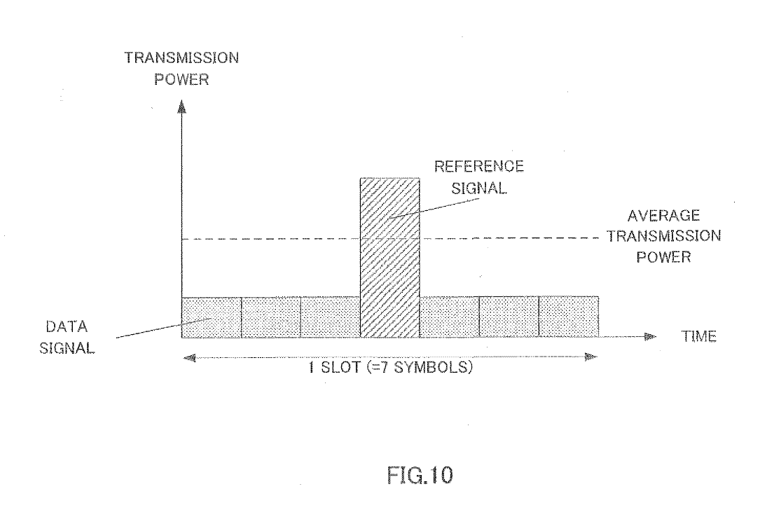

In a case shown in FIG. 9A, the frequency interval between a subject reference signal (reference signal assigned to the second subcarrier from the bottom shown in FIG. 9A) and the reference signal (reference signal assigned to the fourth subcarrier from the bottom) neighboring the subject reference signal, is equivalent to one subcarrier. Therefore, setting section 108 and setting section 157 set the allocation density of the subject reference signal in the time domain to 1/7 because the frequency interval (one subcarrier) is smaller than the threshold. Accordingly, in the transmission band to which a subject reference signal is assigned (the second subcarrier from the bottom shown in FIG. 9A), mapping section 109 maps a reference signal to one symbol among seven symbols.

On the other hand, in a case shown in FIG. 9B, the frequency interval between a subject reference signal (reference signal assigned to the second subcarrier from the bottom shown in FIG. 9B) and the reference signal (reference signal assigned to the fifth subcarrier from the bottom shown in FIG. 9B) neighboring the subject reference signal, is equivalent to two subcarriers. Therefore, setting section 108 and setting section 157 set the allocation density of the subject reference signal in the time domain 2/7 because the frequency interval is equal to or higher than the threshold (two subcarriers.) Accordingly, mapping section 109 maps reference signals to two symbols among seven symbols in the transmission band to which the subject reference signal is assigned (the second subcarrier from the bottom shown in FIG. 9B.)

As shown in FIG. 9A, when a frequency interval between neighboring signals is small, channel correlation is high, so that it is possible to ensure satisfactory accuracy of channel estimation, and to reduce reference signal overhead by decreasing the allocation density of reference signals. By contrast with this, as shown in FIG. 9B, when a frequency interval between neighboring reference signals is greater, channel correlation is lower, but it is possible to improve the accuracy of channel estimation by increasing the allocation density of reference signals in the time domain.

Therefore, in transmission bands in which a frequency interval between neighboring reference signals is smaller, it is possible to reduce reference signal overhead by decreasing the allocation density of reference signals in the time domain. In addition, in transmission bands in which a frequency interval between neighboring reference signals is greater, it is possible to improve the accuracy of channel estimation by increasing the allocation density of reference signals in the time domain.

As described above, with the present embodiment, the allocation density of reference signals in the time domain is set, according to the frequency interval between neighboring reference signals in the frequency domain. By this means, like in setting examples 1 to 3 in Embodiment 1, it is possible to finely set the allocation density of reference signals in the time domain for each of transmission bands, based on the positions of transmission bands used to transmit reference signals from each terminal. By this means, it is possible to improve the accuracy of channel estimation while reference signal overhead is reduced.

Here, with the present embodiment, a case has been explained where a terminal uses the frequency interval between a subject reference signal and one neighboring reference signal. However, according to the present invention, terminals may use a total of frequency intervals between a subject reference signal and its both sides of neighboring reference signals.

### Embodiment 3

Although with Embodiment 1 and Embodiment 2, cases have been explained where the power density of reference signals is set by setting the allocation density of reference signals in the time domain, with the present embodiment, the power density of reference signals is set by setting the transmission power of reference signals.

In addition, with the present embodiment, the proportion of transmission bands for reference signals in a predetermined frequency band is the degree of continuity of reference signals in the frequency domain, like in Embodiment 1.

Setting section 108 (FIG. 2) in terminal 100 according to the present embodiment sets the power density of reference signals by setting the transmission power of reference signals, according to the degree of continuity of reference signals in the frequency domain. In addition, when the degree of continuity of reference signals in the frequency domain is lower, setting section 108 increases the transmission power of reference signals. In other words, when the degree of continuity of reference signals in the frequency domain is lower, setting section 108 increases the proportion of the transmission power to be distributed to reference signals, among the total transmission power to be distributed to data signals and reference signals. Then, setting section 108 outputs transmission power information representing the set transmission power of reference signals, to mapping section 109.

Mapping section 109 maps signals inputted from FFT section 107 and reference signals having the transmission power represented by transmission power information, to resources in the time domain and the frequency domain, as adjusting the power according to transmission power information inputted from setting section 108.

Meanwhile, like setting section 108 (FIG. 2), setting section 157 (FIG. 3) in base station 150 according to the present embodiment sets the power density of reference signals by setting the transmission power of reference signals, according to the degree of continuity of reference signals in the frequency domain. In addition, like setting section 108, setting section 157 increases the transmission power of reference signals when the degree of continuity of reference signals in the frequency domain is lower. Then, setting section 157 outputs transmission power information representing the set transmission power of reference signals, to demapping section 158.

Demapping section 158 extracts data signals and reference signals from frequency domain signals inputted from DFT section 156, as adjusting the power according to the transmission power information inputted from setting section 157.

Next, an example of setting the transmission power of reference signals in setting section 108 and setting section 157 in the present embodiment will be explained.

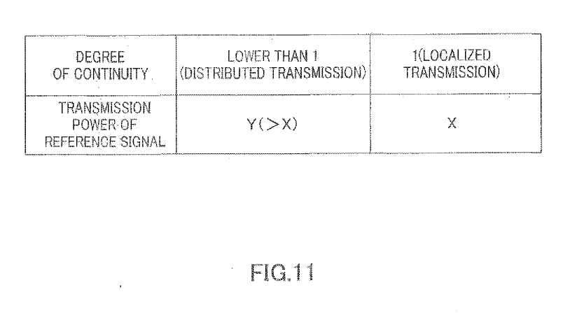

In the following descriptions, one slot (seven symbols) is composed of six symbols for data signals and one symbol for a reference signal as shown in FIG. 10. In addition, as shown in FIG. 10, in terminal 100, the transmission power per slot (seven symbols) is held constant (that is, transmission power per slot=average transmission power x seven symbols), and the transmission power is distributed to each symbol.

Moreover, in the following descriptions, when the magnitude of the transmission power of reference signals is the same as that of the transmission power of data signals, interference to terminal 100 receiving from neighboring cells increases, and, when the transmission power of reference signals is higher than the transmission power of data signals, interference to neighboring cells receiving from terminal 100 increases.

As shown in the above-described FIG. 1B, when the degree of continuity of reference signals in the frequency domain is lower, channel correlation between channel estimation values is lower, and therefore the accuracy of channel estimation deteriorates and reception quality deteriorates. Meanwhile, as for data signals, as shown in FIG. 1B, when an interval in the frequency domain is greater, it is possible to produce frequency diversity effect, so that reception quality is improved. Therefore, as shown in FIG. 1B, when an interval between transmission bands to which data signals and reference signals from terminal 100 are assigned, is greater in the frequency domain, that is, when the degree of continuity of reference signals is lower in the frequency domain, reception quality is improved more by increasing the transmission power of data signals than by increasing the transmission power of reference signals.

Therefore, with the present embodiment, setting section 108 and setting section 157 set the transmission power of reference signals, according to the degree of continuity of reference signals in the frequency domain.

### Setting example 3-1

With this setting example, when the degree of continuity of reference signals in the frequency domain is lower than 1, setting section 108 and setting section 157 increase the transmission power of reference signals more than in a case in which the degree of continuity of reference signals in the frequency domain is 1.

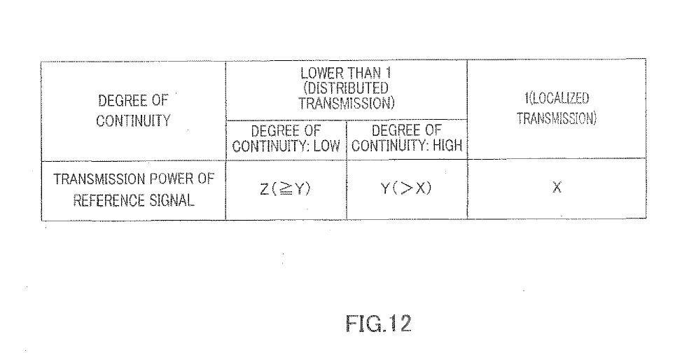

That is, like setting example 1-1 in Embodiment 1, at the time of distributed transmission where the degree of continuity (proportion B/A) is lower than 1 as shown in FIG. 1B, setting section 108 and setting section 157 increase the transmission power of reference signals more than at the time of localized transmission where the degree of continuity (proportion B/A) is the maximum value 1 as shown in FIG. 1A. For example as shown in FIG. 11, at the time of localized transmission where the degree of continuity (proportion B/A) is 1, setting section 108 and setting section 157 set the transmission power of reference signals to X. Here, transmission power X is the same as the transmission power of data signals. On the other hand, at the time of distributed transmission where the degree of continuity (proportion B/A) is lower than 1, setting section 108 and setting section 157 set the transmission power of reference signals to Y that is greater than transmission power Y.

By this means, with distributed transmission, even if a degree of continuity is low and channel correlation between transmission bands assigned to reference signals is low, it is possible to improve the accuracy of channel estimation for terminal 100 by increasing the power density of reference signals, like in setting example 1-1. In other words, with distributed transmission, it is possible to compensate for deterioration of the accuracy of channel estimation due to low channel correlation in the frequency domain by increasing the power density of reference signals. On the other hand, with localized transmission, interference from neighboring cells increases because the magnitude of the transmission power of reference signals is the same as that of the transmission power of data signals, but channel correlation between transmission bands to which reference signals are assigned, is high, so that it is possible to ensure satisfactory accuracy of channel estimation. Therefore, with localized transmission, it is possible to reduce interference to other cells by decreasing the transmission power of reference signals, and it is possible to prevent deterioration of the accuracy of channel estimation in other terminals located in other cells.

As described above, according to this setting example, terminals set the power density of reference signals by setting the transmission power of reference signals, according to the degree of continuity of reference signals in the frequency domain. By this means, at the time of distributed transmission where the degree of continuity is lower than 1, terminal 100 can improve the accuracy of channel estimation by increasing the transmission power of reference signals. Therefore, with this setting example, when both localized transmission and distributed transmission are used, it is possible to ensure the accuracy of channel estimation for localized transmission even by distributed transmission. That is, it is possible to ensure satisfactory accuracy of channel estimation whether the transmission method is localized transmission or distributed transmission.

Moreover, with this setting example, at the time of localized transmission where the degree of continuity is 1, terminals do not increase the transmission power of reference signals. By this means, it is possible to reduce interference of reference signals from terminal 100, which is imparted to other terminals. That is, according to this setting example, at the time of localized transmission where the degree of continuity is 1, it is possible to prevent deterioration of the accuracy of channel estimation in other terminals located in other cells.

Here, with this setting example, a case has been explained where, when the degree of continuity is 1, setting section 108 and setting section 157 set transmission power X, and, when the degree of continuity is lower than 1, set transmission power Y, as shown in FIG. 11. However, according to the present invention, for example, setting section 108 and setting section 157 may set the transmission power of reference signals to X shown in FIG. 11 when the degree of continuity is equal to or higher than a predetermined threshold, and set the transmission power of reference signals to Y shown in FIG. 11 when the degree of continuity is lower than a predetermined threshold.

### Setting example 3-2

With this setting example, when the degree of continuity (proportion B/A) of reference signals in the frequency domain is lower, setting section 108 and setting section 157 increases the transmission power of reference signals.

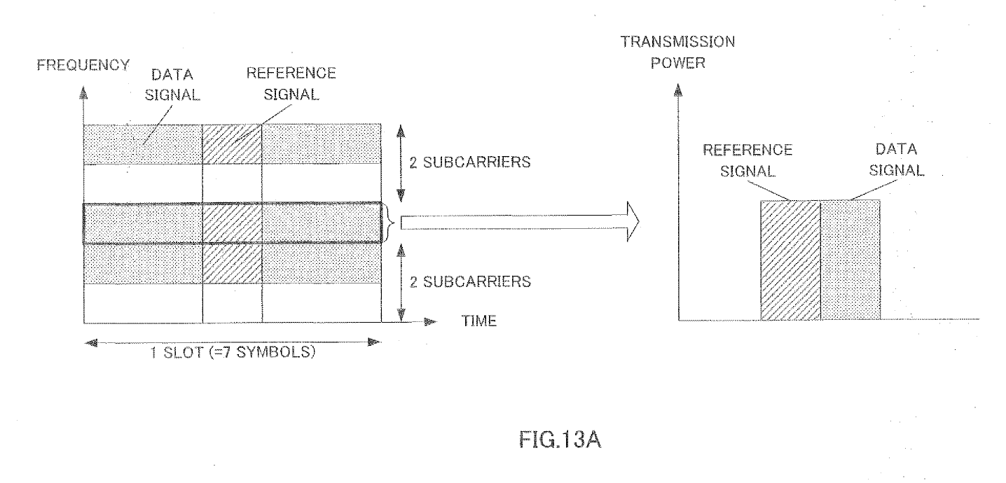

For example, as shown in FIG. 12, when the degree of continuity (proportion B/A) is 1, setting section 108 and setting section 157 set the transmission power of reference signals to X (for example, the same transmission power as that of data signals), like in setting example 3-1.

On the other hand, when the degree of continuity (proportion B/A) is lower than 1, setting section 108 and setting section 157 increase the transmission power of reference signals more than in a case in which the degree of continuity is 1 (proportion B/A.) For example, when the degree of continuity (proportion B/A) is lower than 1, setting section 108 and setting section 157 set the transmission power of reference signals to Y that is higher than the transmission power X, or set transmission power Z equal to or higher than Y, as shown in FIG. 11. Here, when the degree of continuity (proportion B/A) is lower, setting section 108 and setting section 157 increase the transmission power of reference signals. For example, as shown in FIG. 12, as for the degree of continuity (proportion B/A) lower than 1, when the degree of continuity (proportion B/A) is higher, the transmission power of reference signals is set to a value closer to Y. In addition, when the degree of continuity (proportion B/A) is lower, setting section 108 and setting section 157 set the transmission power of reference signals to a value closer to Z. That is, when the degree of continuity (proportion B/A) is lower than 1, setting section 108 and setting section 157 set the transmission power of reference signals to any of Y to Z, according to the degree of continuity (proportion B/A.)

By this means, like in setting example 3-1, when the degree of continuity (proportion B/A) is lower than 1 (distributed transmission), terminal 100 increases the transmission power of reference signals more than in a case in which the degree of continuity (proportion B/A) is 1 (localized transmission.) Moreover, in a case in which the degree of continuity (proportion B/A) is lower than 1 (distributed transmission), terminal 100 increases the transmission power of reference signals when the degree of continuity (proportion B/A) is lower. By this means, at the time of distributed transmission where the degree of continuity (proportion B/A) is lower than 1, terminal 100 can finely set the transmission power of reference signals more than in setting example 3-1, according to the degree of continuity (proportion B/A.) That is, terminal 100 can finely set the transmission power of reference signals according to the degree of continuity (proportion B/A), so that it is possible to prevent increase in the transmission power of reference signals.

As described above, according to this setting example, it is possible to improve the accuracy of channel estimation in terminal 100 while interference to other cells at the time of distributed transmission where the degree of continuity is lower than 1.

### Setting example 3-3

With this setting example, a case will be explained where frequency bands in a predetermined range around a transmission band (subcarrier) for reference signals are a predetermined frequency band like in setting example 1-3 in Embodiment 1.

That is, with the present embodiment, the proportion of transmission bands for reference signals to frequency bands around each transmission band for reference signals in a predetermined range is used as a degree of continuity. For example, when the proportion (continuity) of the transmission bands for reference signals in a predetermined frequency band is lower than a threshold, setting section 108 and setting section 157 set the transmission power of reference signals higher, and, when the proportion (continuity) of the transmission bands of reference signals to a predetermined frequency band is equal to or higher than a threshold, set the transmission power of reference signals the same as that of data signals.

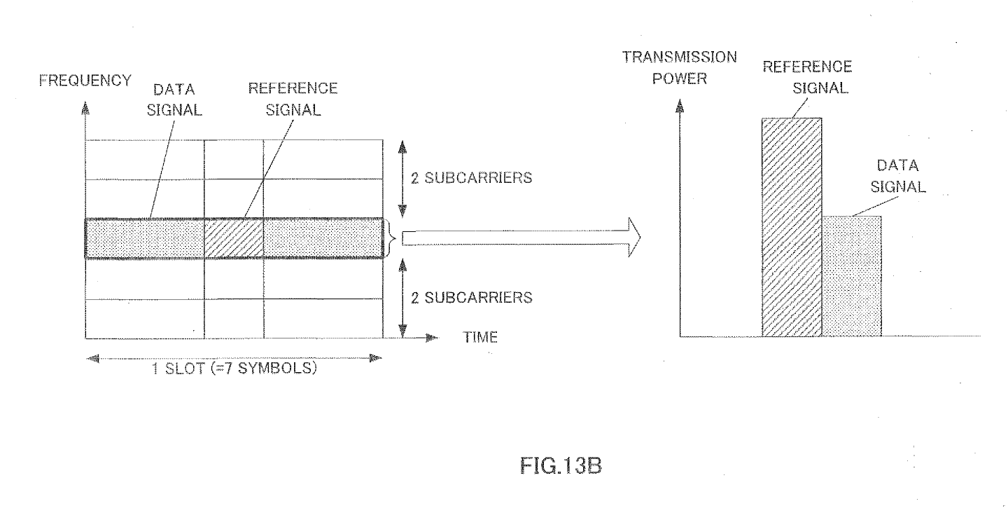

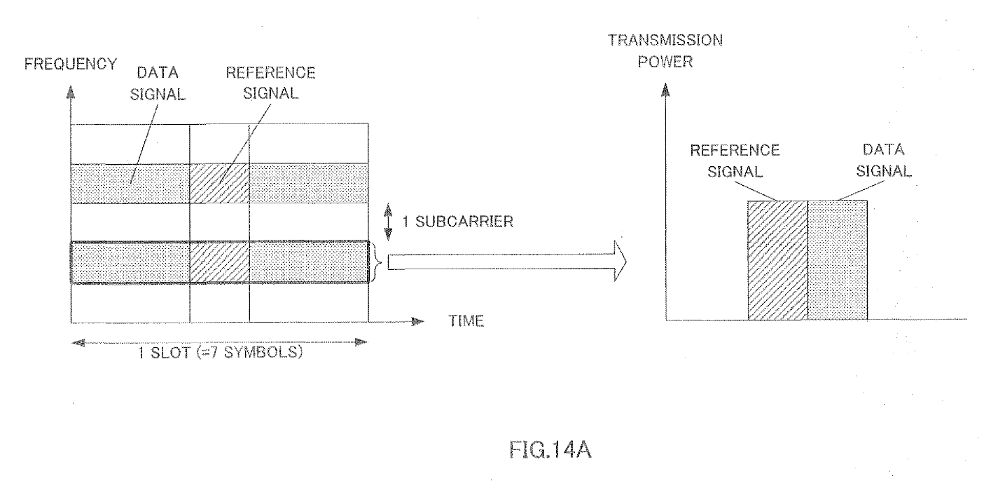

Now, specific descriptions will be explained. Here, like setting examples 1-3 in Embodiment 1, four subcarriers composed of two subcarriers before a subject transmission band (for example, the center subcarrier of five subcarriers shown in FIG. 13A and FIG. 13B) and two subcarriers after the subject subcarrier are frequency bands in a predetermined range, that is, predetermined frequency bands. In addition, a threshold is ½.

As shown in the left side of FIG. 13A, the proportion (continuity) of transmission bands (two subcarriers) for reference signals to predetermined frequency bands (four subcarriers) is ½ (= 2/4.) Accordingly, the proportion (continuity) is higher than the threshold, so that setting section 108 and setting section 157 set the same transmission power of reference signals in the subject transmission band as the transmission power of data signals as shown in the right side of FIG. 13A.

On the other hand, as shown in the left side of FIG. 13B, the proportion (continuity) of transmission bands (zero subcarrier) for reference signals to predetermined frequency bands (four subcarriers) is 0 (= 0/4.) Accordingly, the proportion (continuity) is lower than the threshold, so that setting section 108 and setting section 157 set the transmission power of higher reference signals in the subject transmission band higher than the transmission power in the case shown in FIG. 13A, that is, set higher transmission power than the transmission power of data signals, as shown in the right side of FIG. 13B.

By this means, as shown in FIG. 13A, when the proportion of transmission bands for reference signals occupying in predetermined frequency bands is high, channel correlation between a subject transmission band and frequency bands in a predetermined range increases, so that it is possible to ensure satisfactory accuracy of channel estimation without increase in the transmission power of reference signals. By contrast with this, as shown in FIG. 13B, when the proportion of transmission bands for reference signals occupying in predetermined frequency bands is low, channel correlation between a subject transmission band and frequency bands in a predetermined range decreases, but it is possible to improve the accuracy of channel estimation by increasing the transmission power of reference signals.

In this way, terminal 100 sets the transmission power of reference signals, depending on the degree of continuity for each of transmission bands assigned to reference signals from terminal 100. By this means, in transmission bands with a low degree of continuity, it is possible to improve the accuracy of channel estimation in terminal 100 by increasing the transmission power of reference signals. In addition, in transmission bands with a high degree of continuity, it is possible to reduce interference to other cells by decreasing the transmission power of reference signals.

Therefore, according to this setting example, it is possible to finely set the transmission power of reference signals on a per transmission band basis, based on the positions of transmission bands used to transmit reference signals from each terminal. By this means, it is possible to improve the accuracy of channel estimation in terminal 100 while reducing interference to other cells.

Setting examples 3-1 to 3-3 for the transmission power of reference signals have been explained.

As described above, according to the present embodiment, when a degree of continuity of reference signals in the frequency domain is lower, a terminal increases the transmission power of reference signals. By this means, the power density of reference signals increases, so that it is possible to compensate for deterioration of the accuracy of channel estimation in the frequency domain. Therefore, according to the present embodiment, when both localized transmission and distributed transmission are employed, it is possible to ensure the accuracy of channel estimation for localized transmission even by distributed transmission. That is, when both localized transmission and distributed transmission are employed, it is possible to ensure satisfactory accuracy of channel estimation whether localized transmission or distributed transmission is used.

Moreover, according to the present embodiment, when a degree of continuity is higher, the transmission power of reference signals decreases, so that it is possible to reduce interference to other cells.

Here, with the present embodiment, when a degree of continuity of reference signals in the frequency domain is lower, a base station may select whether or not to increase the transmission power of reference signals. For example, while a base station may set the same the transmission power of reference signals as data signal transmission power in localized transmission with a high degree of continuity, like in the above-described embodiments, the base station may select whether or not to increase the transmission power of reference signals more than data signal transmission power in distributed transmission with a low degree of continuity.

### Embodiment 4

With the present embodiment, a case will be explained where a frequency interval between neighboring reference signals in the frequency domain is the degree of continuity of reference signals in the frequency domain like in Embodiment 2, and the power density of reference signals is set by setting the transmission power of reference signals like in Embodiment 3.

That is, setting section 108 (FIG. 2) in terminal 100 and setting section 157 (FIG. 3) in base station 150 in the present embodiment set the transmission power of reference signals, according to a frequency interval between neighboring reference signals in each of transmission bands to which reference signals from terminal 100 are assigned. Here, when a frequency interval between neighboring reference signals is greater (that is, when a degree of continuity is lower), setting section 108 and setting section 157 increase the transmission power of reference signals. In addition, when a frequency interval between neighboring reference signals is greater than a threshold, setting section 108 and setting section 157 increase the transmission power of reference signals, and, when a frequency interval between neighboring reference signals is smaller than a threshold, set the same transmission power of reference signals as data signal transmission power.

Now, specific description will be explained. In the following descriptions, like in Embodiment 3, one slot (seven symbols) is composed of six symbols for data signals and one symbol for a reference signal as shown in FIG. 10. In addition, as shown in FIG. 10, in terminal 100, the transmission power per slot (seven symbols) is held constant, and distributed to each symbol. In addition, the threshold of a frequency interval is two subcarriers.

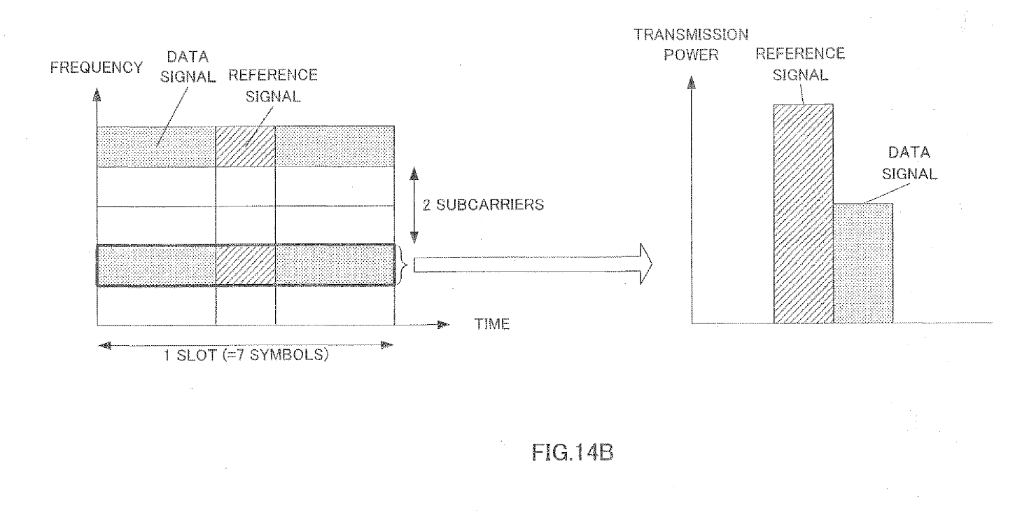

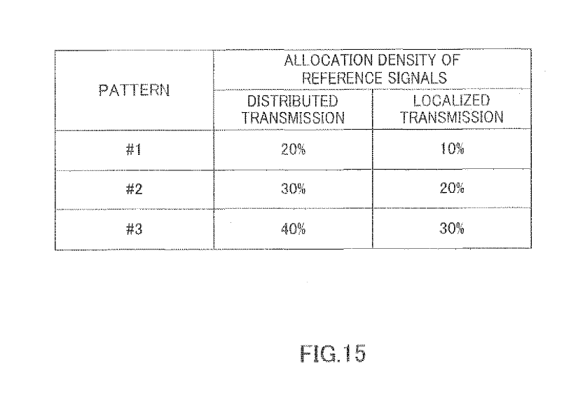

In a case shown in FIG. 14A, the frequency interval between a subject reference signal (reference signal assigned to the second subcarrier from the bottom shown in the left side of FIG. 14A) and the reference signal (reference signal assigned to the fourth subcarrier from the bottom shown in FIG. 14A) neighboring the subject reference signal, is one subcarrier. Accordingly, the frequency interval (one subcarrier) is smaller than the threshold, so that setting section 108 and setting section 157 set the same transmission power of reference signals as data signal transmission power, as shown in the right side of FIG. 14A.

On the other hand, in a case shown in FIG. 14B, the frequency interval between a subject reference signal (reference signal assigned to the second subcarrier from the bottom shown in the left side of FIG. 14B) and the reference signal (reference signal assigned to the fifth subcarrier from the bottom shown in the left side of FIG. 14B) neighboring the subject reference signal, is equivalent to two subcarriers. Accordingly, the frequency interval (two subcarriers) is greater than the threshold, so that setting section 108 and setting section 157 set the transmission power of reference signal higher than the transmission power in the case shown in FIG. 14A, that is, set higher transmission power than data signal transmission power, as shown in the right side of FIG. 14B.

As shown in FIG. 14A, when the frequency interval between neighboring reference signals is small, channel correlation is high, so that it is possible to ensure satisfactory accuracy of channel estimation, and it is possible to reduce interference to other cells by decreasing the transmission power of reference signals. By contrast with this, as shown in FIG. 14B, when the frequency interval between neighboring reference signals is great, channel correlation is low, but it is possible to improve the accuracy of channel estimation by increasing the transmission power of reference signals.

Therefore, in transmission bands for reference signals where the frequency interval between neighboring reference signals is small, it is possible to reduce interference to other cells by decreasing the transmission power of reference signals. On the other hand, in transmission bands for reference signals where the frequency interval between neighboring reference signals is great, it is possible to improve the accuracy of channel estimation by increasing the transmission power of reference signals.

In this way, according to the present embodiment, like in Embodiment 2, it is possible to finely set the transmission power of reference signals per transmission band, based on the positions of transmission bands used to transmit reference signals from each terminal. By this means, it is possible to improve the accuracy of channel estimation while minimizing interference to other cells.

Here, with the present embodiment, a case has been explained where a terminal uses a frequency interval between a subject reference signal and one neighboring reference signal. However, according to the present embodiment, a terminal may use the total of frequency intervals between a subject reference signal and both sides of neighboring reference signals.

Each embodiment of the present invention has been explained.

Here, with the above-described embodiments, allocation density in the time domain has been explained as the allocation density of reference signals as shown in FIG. 4A and FIG. 4B. However, according to the present invention, the allocation density of reference signals may be an allocation density in two dimensions, that is, in the frequency domain and the time domain. In addition, the allocation density of reference signals is not limited to an allocation density in the frequency domain and the time domain, but, for example, an allocation density in the time domain and the spatial domain is possible. Moreover, the allocation density of reference signals is not limited to an allocation density in two dimensions, the frequency domain and the time domain, but an allocation density in three dimensions including the spatial domain, in addition to the frequency domain and the time domain.

Furthermore, with the above-described embodiments, for example, as shown in FIG. 4B, a case has been explained where transmission bands for reference signals are distributed every subcarrier. However, according to the present invention, reference signal transmission bands equivalent to a number of consecutive subcarriers (e.g. twelve subcarriers) constitute one group, and each group may be distributed in a wide band. In addition, with the above-described embodiment, as shown in FIG. 4B, the case has been explained where reference signal transmission bands are distributed at even intervals (two subcarrier intervals in FIG. 4B.) However, in the present invention, reference signal transmission bands may not be distributed at even intervals.

In addition, with the above-described embodiments, cases have been explained where the proportion of the number of reference signals allocated to symbols (e.g. seven symbols) in one slot is the allocation density of reference signals in the time domain. However, in the present invention, for example, the proportion of the number of reference signals allocated to one slot, to data signals, may be the allocation density of reference signals in the time domain. For example, when six symbols are assigned to data signals and one symbol is assigned to a reference signal, among seven symbols in one slot, the allocation density of reference signals in the time domain is ⅙. In addition, when five symbols are assigned to data signals and two symbols are assigned to reference signals, among seven symbols in one slot, the allocation density of reference signals in the time domain is ⅖.

Moreover, with the above-described embodiments, cases have been explained as examples where the present invention is applied to localized transmission and distributed transmission. However, in the present invention, SC-FDMA (Single Carrier-Frequency Division Multiplexing Access) transmission may be applied instead of localized transmission, and OFDMA (Orthogonal Frequency Division Multiplexing Access) may be applied instead of distributed transmission. Alternately, the present invention may be applied to OFDMA transmission that is a combination of localized transmission and distributed transmission. In addition, for example, transmission between a base station (eNB) and a relay station (RS) may be applied instead of localized transmission, and transmission between a relay station (RS) and a terminal (UE) may be applied to distributed transmission. Generally, reception performances between a relay station (RS) and a terminal (UE) is poorer than those between a base station (eNB) and a relay station (RS). Therefore, application of the present invention increases the allocation density of reference signals at the time of transmission between a relay station (RS) and a terminal (UE), so that it is possible to improve the accuracy of channel estimation and improve reception performances.

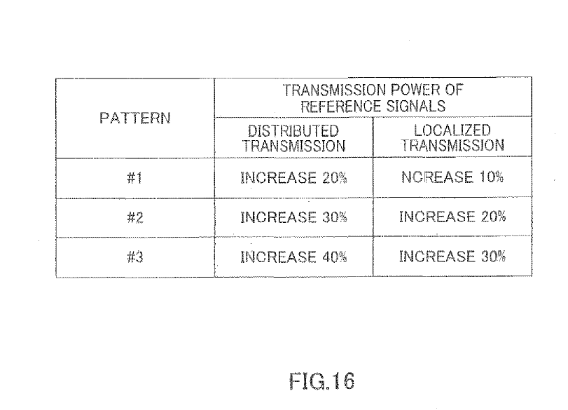

In addition, in the present invention, terminals and a base station may have a table representing setting patterns including a plurality of associations between degrees of continuity of reference signals in the frequency domain and reference signal power densities. For example, when the allocation density of reference signals in the time domain is used as the power density of reference signals, the table shown in FIG. 15 is used. Here, the allocation density shown in FIG. 15 represents the proportion of the number of reference signals allocated to symbols in one slot. As shown in FIG. 15, the allocation density of reference signals in the time domain varies for each of patterns #1 to #3. To be more specific, the allocation density represented by pattern #1 is the lowest and the allocation pattern represented by pattern #3 is the highest. In addition, in each pattern, the allocation density of reference signals in the time domain at the time of distributed transmission is set higher than the allocation density of reference signals in the time domain at the time of localized transmission.

Moreover, for example, when the transmission power of reference signals is used as the power density of reference signals, the table shown in FIG. 16 is used. Here, each transmission power of reference signals shown in FIG. 16 represents the proportion of increasing data signals to transmission power. As shown in FIG. 16, the transmission power of reference signals varies for each of patterns #1 to #3. To be more specific, the transmission power represented by pattern #1 is lowest and the transmission power represented by pattern #3 is highest. In addition, in each pattern, the transmission power of reference signals at the time of distributed transmission is set higher than the transmission power of reference signals at the time of localized transmission.

Then, a base station selects any of a plurality of associations (patterns #1 to #3) in FIG. 15 or FIG. 16, and reports the selected pattern to a terminal. Then, the terminal receives the pattern reported from the base station, refers to a table based on information representing its setting pattern information and transmission method (localized transmission or distributed transmission), and sets the power density of reference signals. By this means, a base station can flexibly change the power density of reference signals (allocation density of reference signals in the time domain or the transmission power of reference signals), depending on, for example, variations of a propagation environment, and it is possible to improve the accuracy of channel estimation while reducing reference signal overhead or interference to other cell, like in the above-described embodiments.

In addition, with the above-described embodiments, although examples are used where data and reference signals are transmitted in the uplink from terminals to a base station, the present invention is applicable to transmission in the downlink from a base station to terminals.

Moreover, the present invention is applicable to a case in which reference signals are ZC (Zadoff Chu) sequences. In this case, in distributed transmission in which reference signals are assigned to discontinuous transmission bands (that is, the degree of continuity is lower than 1), an effect of removing interference by ZC sequences significantly reduces, as compared to localized transmission in which reference signals are assigned to consecutive transmission bands (that is, the degree of continuity is 1.) Therefore, application of the present invention is effective for the case in which reference signals are ZC sequences.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-202098, filed on Aug. 5, 2008, including the specification, drawings and abstract, is incorporated herein by reference in its entirety.

### INDUSTRIAL APPLICABILITY

The present invention is applicable to a mobile communication system and so forth.

1. A radio communication apparatus comprising:
a setting section that sets a power density of reference signals, according to a degree of continuity of the reference signals in a frequency domain; and
a transmitting section that transmits the reference signals having the power density,
wherein,
when the degree of continuity is lower, the setting section increases the power density.

2. The radio communication apparatus according to claim 1, wherein
the setting section sets the power density by setting an allocation density of the reference signals in a time domain, and, when the degree of continuity is lower, increases the allocation density.

3. The radio communication apparatus according to claim 1, wherein
the setting section sets the power density by setting transmission power of the reference signals, and, when the degree of continuity is lower, increases the transmission power.

4. The radio communication apparatus according to claim 1, wherein
the setting section uses a proportion of transmission bands for the reference signals to a predetermined frequency band as the degree of continuity, and, when the proportion is lower, increases the power density.

5. The radio communication apparatus according to claim 1, wherein
the setting section uses a frequency interval between neighboring reference signals as the degree of continuity, and, when the frequency interval is greater, increases the power density.

6. The radio communication apparatus according to claim 1, wherein
the setting section increases a power density at a time when the degree of continuity is lower than 1, more than a power density at a time when the degree of continuity is 1.

7. The radio communication apparatus according to claim 1, further comprising a receiving section that receives a setting pattern including a plurality of associations between degrees of continuity and power densities,
wherein
the setting section sets the power density based on the setting pattern.

8. A power density setting method of setting a power density of reference signals, according to a degree of continuity of the reference signals in a frequency domain,
wherein,
when the degree of continuity is lower, the power density is increased.
